(19) United States
(12) Patent Application Publication
(10) Pub. No.: US 2007/0265744 A1
(43) Pub. Date: Nov. 15, 2007

(54) Vehicle information system and method

(75) Inventor: William G. Nicolai, Davison, MI (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 11/433,730

(22) Filed: May 12, 2006

(51) Int. Cl. G01M 17/00; G06F 17/00

(52) U.S. Cl. 701/35; 701/2

(57) ABSTRACT

A method for use in a vehicle information system that includes identifying a user of a vehicle, wirelessly receiving content data in a vehicle from a data center, where the content includes at least one of multimedia content and navigation content, and delivering the content to the user. Also, a vehicle information system for use in a vehicle, including a controller and a storage connected to be accessed by the controller. The vehicle information system is capable of identifying a user of the vehicle, wirelessly receiving content data in the vehicle from a data center, and delivering the content to the user. The content can include multimedia content and navigation content.

### TECHNICAL FIELD OF THE INVENTION

The present invention is directed, in general, to vehicle information systems, and in particular to information systems for personal and business automobiles.

### BACKGROUND OF THE INVENTION

Drivers increasingly demand additional information services from their vehicles. One common system is the ONSTAR system by the General Motors Corporation. ONSTAR offers such features as an integrated telephone with speakerphone capabilities, an integrated global positioning system (GPS) receiver, collision sensors, and remote door unlocking. ONSTAR uses the GPS receiver to allow the ONSTAR service center to track the vehicle, so that when a driver phones the ONSTAR service center, a customer service agent can answer questions specific to the vehicle's location.

The collision sensors are used for the ONSTAR system to detect a vehicle collision and automatically alert the ONSTAR service center, so that a customer service agent can telephone the vehicle and, if necessary, notify emergency workers.

ONSTAR is primarily driven by voice interaction between the driver and the ONSTAR customer service agent. It would be desirable to have a vehicle information system that enabled automatic interaction between a vehicle-based information system and a remote server.

### SUMMARY OF THE INVENTION

One disclosed embodiment includes a method for use in a vehicle information system that includes identifying a user of a vehicle, wirelessly receiving content data in a vehicle from a data center, where the content includes at least one of multimedia content and navigation content, and delivering the content to the user.

Another disclosed embodiment includes a vehicle information system for use in a vehicle, including a controller and a storage connected to be accessed by the controller. The vehicle information system is capable of identifying a user of the vehicle, wirelessly receiving content data in the vehicle from a data center, and delivering the content to the user. The content can include multimedia content and navigation content.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts an exemplary block diagram of a system context in accordance with a disclosed embodiment;

FIG. 2 depicts an exemplary block diagram of a vehicle in accordance with a disclosed embodiment of the present invention;

FIG. 3 depicts a flowchart of a process in accordance with a disclosed embodiment; and

FIG. 4 depicts a flowchart of support processes in accordance with a disclosed embodiment.

### DETAILED DESCRIPTION OF THE INVENTION

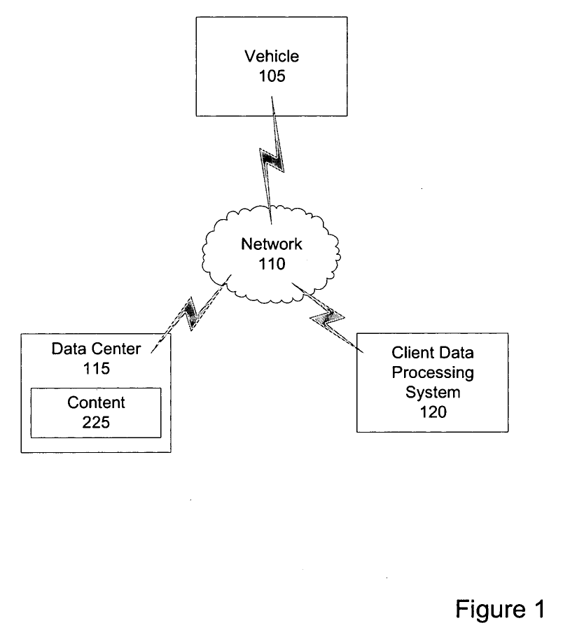

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

FIG. 1 depicts an exemplary block diagram of a system context in accordance with a disclosed embodiment.

FIG. 1 includes an exemplary vehicle 105, described in more detail below, which communicates wirelessly with network 110. Network 110 can be implemented using a combination of wireless and wired networks, and both public and private networks. In one disclosed embodiment, network 110 includes a propriety wireless/wired network, such as a common cellular telephone network, that is capable of communicating data calls and optionally voice call with vehicle 105. In this embodiment, network 110 is also connected to communicate with data center 115, described in more detail below, which can be a part of a proprietary network, or can be part of another public or private network, including the Internet, all collectively included in network 110.

FIG. 1 also includes a client data processing system 120 suitable for use in both residential and commercial environments, connected to communicate with network 110 and thereby to communicate with data center 115. The particular hardware implementation of client data processing system 120 is unimportant, and can be implemented using known common data processing systems. No additional components are required for the client data processing system 120, in a preferred embodiment, other than a common World Wide Web browser.

Note that the infrastructure and hardware necessary to implement network 110, including various base stations, routers, gateways, and other equipment, are well known to those of skill in the art and so are not described in detail herein.

Data center 115, in this example, includes multiple data processing system servers, as will be described below, which can be either commonly located or located in different places, and indeed may be operated by different parties in order to perform the functions described. Data center 115 is intended to represent one or more server data processing systems capable of performing the functions described herein, and providing content 225 as described herein, and can be implemented using commonly-available data processing system hardware.

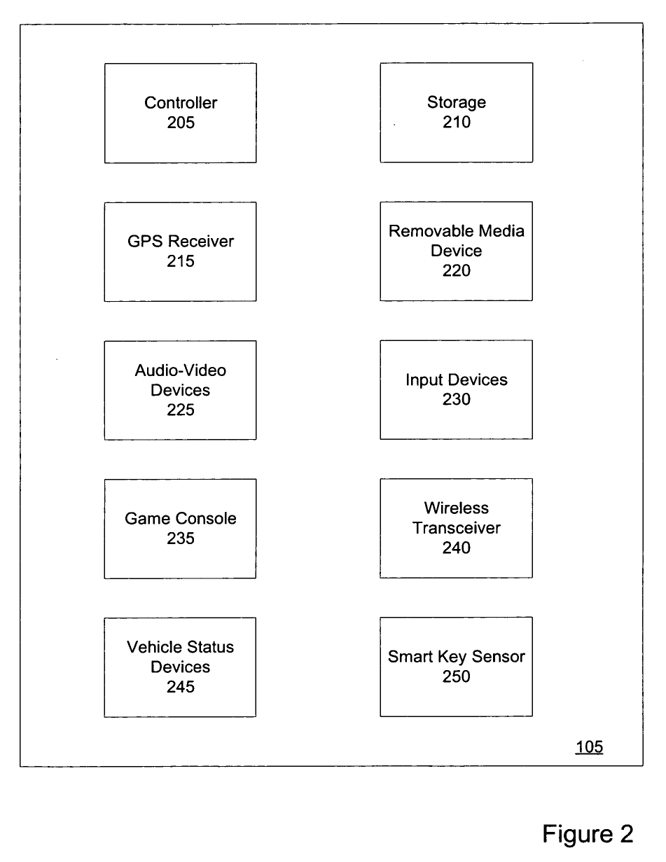

FIG. 2 depicts an exemplary block diagram of a vehicle 105 in accordance with a disclosed embodiment of the present invention, including various components used to implement the functions described herein. Vehicle 105 can be any personal or commercial passenger vehicle, and unless specifically described differently below, the structure and operation of the vehicle itself is conventional and so not described in detail. Vehicle 105 maybe commonly referred to as but not limited to passenger car, light duty truck, medium duty truck, van, mini-van, crossover vehicle, sport utility vehicle, bus, or common vehicle.

Vehicle 105 includes a controller 205, which can be implemented as a single device or as multiple devices that communicate with each other to perform the functions described herein. Controller 205 is connected to read and write to at least one storage 210, which includes both volatile and non-volatile memory.

Controller 205 is also connected to communicate with global positioning system (GPS) receiver 215, which is capable of receiving GPS signals from GPS satellites. Together, controller 205 and GPS receiver 215 are capable of determining the geographic location of the vehicle 105 at any point in time, and the direction and rate of travel when the vehicle 105 is moving. These basic functions are common in many vehicles, and can be implemented in ways known to those of skill in the art.

In at least one embodiment, controller 205 is also connected to communicate with removable media device 220, which can read and/or write to a removable media. In various embodiments, removable media device can include a compact disk or digital versatile disk (DVD) reader and/or writer, a flash memory reader/writer, or any other commonly-known removable media device. The removable media device can be used as part of an entertainment system, such as for playing DVD videos or audible compact disks.

Controller 205 is also preferably connected to operate one or more audio-video devices 225 for displaying information or other content to the driver or passenger on a video display or playing audible content to the driver or passenger over a speaker system.

Controller 205 is also preferably connected to communicate with one or more input devices 230 for receiving input from the driver or a passenger, as described herein. Input devices 230 can include any common devices such as a keyboard, mouse, remote control, switches buttons, and others. In particular, input devices 230 can include a display that includes a touchscreen as part of audiovideo devices 225.

In some embodiments, controller 205 is also connected to communicate with a game console 235, known to those of skill in the art.

Controller 205 is also connected to communicate with wireless transceiver 240, which itself communicates with network 110 as described herein. Transceiver 240 can communicate data to and from network 110, and can optionally also communicate voice or voice-over-IP data. If transceiver 240 is configured to also communicate voice, then it also includes suitable speaker and microphone capabilities. Wireless transceiver 240 can include more than one actual transceiver device, as may be required for a particular implementation based on the types of data and voice that may be transmitted.

Controller 205 is also connected to communicate with vehicle status devices 245, which can include speed sensors, collision sensors, braking sensors, or any number of other sensors which detect the status of the vehicle 105 or its operation, as known to those of skill in the art.

In some embodiments, controller 205 is also connected to communicate with a “smart key” sensor 250. In these embodiments, each smart key is capable of operating the vehicle 105, and also includes an identifier to distinguish it from other keys to the vehicle. The identifier can be, for example, a radio-frequency identification (RFID) transponder, a wired identification microchip, a magnetically-encoded serial number, or other known identifier. In some embodiments, the identifier is not in the key itself, but is part of a keyless-entry remote control. The smart key sensor 250 is capable of identifying the specific key (or remote control) used and communicating this to the controller 205, which can then distinguish between vehicle drivers. Storage 210 can store user profile information corresponding to each smart key so that vehicle information system services can be configured to each user.

Various embodiments of the present disclosure include innovative vehicle information systems and methods, described below.

Entertainment: In some embodiments, multimedia content can be delivered from data center 115, over network 110, to transceiver 240 in vehicle 105, to be used by controller 205 and/or stored in storage 210. The multimedia content can include movies, music, audiobooks, or other digital content suitable for audio-video devices 225, or can include games for use with game console 235. Data center 115, in these embodiments, includes one or more libraries of multimedia content, and may also be capable of billing a customer for the download of any multimedia content either as a rental or purchased product.

Navigation: In some embodiments, navigation content can be delivered from data center 115, over network 110, to transceiver 240 in vehicle 105, to be used by controller 205 and/or stored in storage 210. While those of skill in the art will recognize that basic mapping and routing functions are well known, in disclosed embodiments, the navigation content can include additional information not found in conventional systems. For example, the navigation content can include real-time traffic information, which can be used for more efficient routing to avoid slow traffic or construction. In some embodiments, the navigation content can include weather data, and specifically real-time weather data and forecasts for a destination location, to aid in travel planning. In some embodiments, the navigation content can include other travel-related data such as the locations and current pricing of nearby gas stations.

In any of these cases, the navigation content can be combined with conventional mapping and routing functions to provide the driver or passengers with enhanced navigation capabilities, as the navigation content is provided to the user through audiovideo devices 225.

Vehicle monitoring: In some embodiments, vehicle monitoring data can be collected by vehicle 105, and delivered to data center 115, via transceiver 240 and over network 110. The vehicle monitoring data can be collected by controller 205 from vehicle status devices 245 and from GPS receiver 215 and stored in storage 210. In various embodiments, the vehicle monitoring data can be accessed in vehicle 105 using audio-video devices 225. In various embodiments, the vehicle monitoring data is delivered to data center 115, and can then be accessed by client data processing system 120 over network 110. The vehicle monitoring data can be used to monitor the physical condition and performance of vehicle 105, and can be used to review or rate the driving habits of one or more drivers of vehicle 105. In some embodiments, the vehicle monitoring data can include real-time or logged GPS tracking of the location of the vehicle at some or all times.

Smart key sensor 250 can be used in conjunction with smart keys to identify the particular driver associated with specific vehicle monitoring data when information regarding the smart key being used is stored with the vehicle status data. In various embodiments, the vehicle monitoring data can be accessed as a stored historical data, or as the real-time status of the vehicle. This is particularly useful for parental monitoring of their children's driving habits.

In various embodiments, to ensure privacy, wireless transceiver 240 can be disabled entirely, preventing any vehicle status data, vehicle location data, or any other voice or data from being transmitted by vehicle 105.

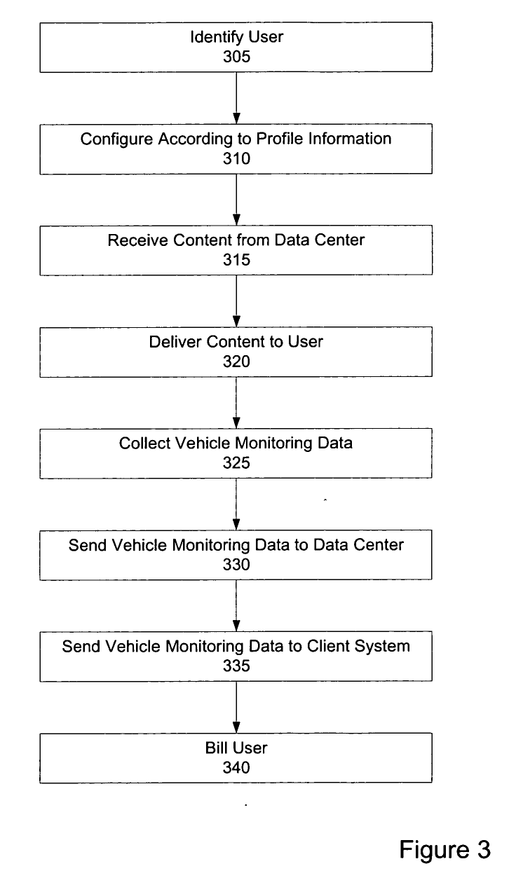

FIG. 3 depicts a flowchart of a process in context of the vehicle 105, and in accordance with a disclosed embodiment.

Here, when a driver enters or starts the vehicle 105 using a smart key, the smart key sensor is 250 detects the key so that the controller 205 of the vehicle information system can identify the user (step 305).

In response, the vehicle information system will configure itself using stored user profile information corresponding to the user identification (step 310).

The vehicle information system will then receive content from the data center 115 (step 315). This content can include multimedia content or navigation content, as described herein, in addition to conventional data or content that may be available. In some embodiments, this content is downloaded automatically according to the stored user profile information. In conjunction with this step, the vehicle information system transmits the user identification to be received by the data center, and the data center transmits the content to be received by the vehicle information system.

The system will deliver the content to the user (step 320), using the appropriate audio-visual devices.

The vehicle information system will also optionally collect vehicle monitoring data (step 325), and if it is collected, can optionally transmit the vehicle monitoring data to the data center (step 330). In conjunction with this step, the data center receives the vehicle monitoring data, and can store it along with the user identification.

The data center can send the vehicle monitoring data, or corresponding data, to a client data processing system for review and analysis (step 335).

The system or the data center can then bill optionally bill the user for the content or other data (step 340), either on a flat rate, periodic, or ad hoc billing basis. If the specifically identified, each user can be individually billed for services or content, without necessarily billing the car owner or other drivers or passengers.

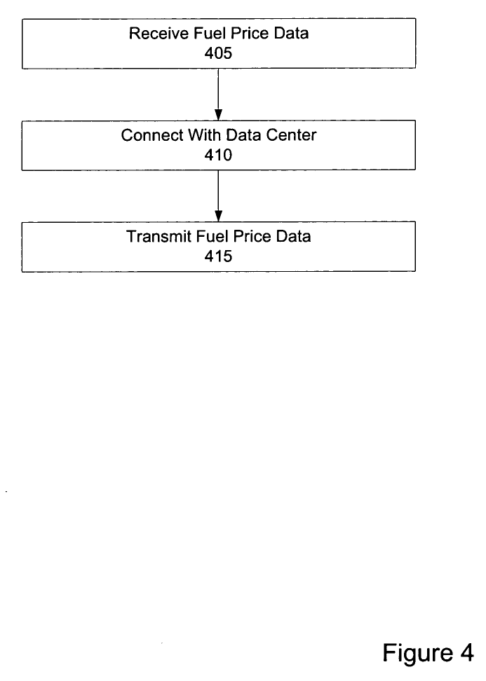

FIG. 4 depicts a flowchart of support processes in accordance with a disclosed embodiment.

Here, when a service station changes the fuel pricing, both fuel pump pricing and advertisement billboard are adjusted accordingly. The new fuel pricing data is entered into and received by a client data processing system 120, typically located at the service station.

The service station would logs to the data center 115 using the client data processing system 120, so that client data processing system connects with the data center 115. Initial login would identify the location of the service station whereas subsequent logins would bypass service station location.

Updated fuel price data, which can include pricing, fuel grade information, and other related information, is then transmitted to data center 115 to be stored in the content 225.

Although FIGS. 3 and 4 illustrates exemplary methods in accordance to various embodiments, various changes may be made to the methods disclosed in these figures. For example, one, some, or all of the steps may occur as many times as needed. Also, while shown as a sequence of steps, various steps in these figures could occur in parallel or in a different order.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of any disclosed data processing system may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A method, comprising:
identifying a user of a vehicle;
wirelessly receiving content data in a vehicle from a data center, the content data including at least one of multimedia content and navigation content; and
delivering the content to the user.

2. The method of claim 1, further comprising billing the user for the received content.

3. The method of claim 1, further comprising configuring at least some part of the vehicle according to user profile data corresponding to the user identification.

4. The method of claim 1, wherein the multimedia content includes audio-video content for delivery to the user by an audio-video device.

5. The method of claim 1, wherein the wherein the multimedia content includes movies.

6. The method of claim 1, wherein at least some content data is automatically identified according to the user identification.

7. The method of claim 1, wherein the navigation content includes locations and pricing for at least one gas station selected according to a location of the vehicle.

8. The method of claim 1, wherein the navigation content includes weather data corresponding to a vehicle destination.

9. The method of claim 1, wherein the navigation content includes real-time traffic data.

10. The method of claim 1, further comprising collecting vehicle monitoring data.

11. The method of claim 10, further comprising sending the vehicle monitoring data to the data center.

12. The method of claim 10, wherein the vehicle monitoring data is accessible by a client data processing system.

13. A vehicle information system for use in a vehicle, comprising:
a controller; and
a storage connected to be accessed by the controller,
wherein the vehicle information system is configured for identifying a user of the vehicle, wirelessly receiving content data in the vehicle from a data center, wherein the content includes at least one of multimedia content and navigation content, and delivering the content to the user.

14. The vehicle information system of claim 13, wherein the data center is capable of billing the user for the received content.

15. The vehicle information system of claim 13, wherein the vehicle information system is further capable of configuring at least some part of the vehicle according to user profile data corresponding to the user identification.

16. The vehicle information system of claim 13, wherein the multimedia content includes audio-video content for delivery to the user by an audio-video device.

17. The vehicle information system of claim 13, wherein the wherein the multimedia content includes movies.

18. The vehicle information system of claim 13, wherein at least some content data is automatically identified according to the user identification.

19. The vehicle information system of claim 13, wherein the navigation content includes locations and pricing for at least one gas station selected according to a location of the vehicle.

20. The vehicle information system of claim 13, wherein the navigation content includes weather data corresponding to a vehicle destination.

21. The vehicle information system of claim 13, wherein the navigation content includes real-time traffic data.

22. The vehicle information system of claim 13, wherein the vehicle information system is further capable of collecting vehicle monitoring data.

23. The vehicle information system of claim 22, wherein the vehicle information system is further capable of sending the vehicle monitoring data to the data center.

24. The vehicle information system of claim 21, wherein the vehicle monitoring data is accessible by a client data processing system.
